(19) United States
(12) Patent Application Publication
(10) Pub. No.: US 2024/0204469 A1
(43) Pub. Date: Jun. 20, 2024

(54) Equipment for Stripping Package

(71) Applicant: Shinda (Tangshan) Creative Oil&Gas Equipment Co., Ltd., Hebei (CN)

(72) Inventors: Qifa Sun, Hebei (CN); Jianliang Duan, Hebei (CN); Jian Dong, Hebei (CN)

(21) Appl. No.: 17/794,617

(22) PCT Filed: Feb. 21, 2022
(86) PCT No.: PCT/CN2022/076998

§ 371 Date: Aug. 17, 2023

(30) Foreign Application Priority Data
Feb. 14, 2022 (CN) 202210134464.6

(51) Int. Cl. H01R 43/28

(52) U.S. Cl. CPC H01R 43/28

(57) ABSTRACT

Equipment for stripping package includes a supporting frame, a driving air motor, a pressing assembly and a feeding carrier plate, wherein the pressing assembly is mounted in an interior of the supporting frame, an output end of the driving air motor is in transmission connection with the pressing assembly, and a feeding end of the supporting frame is connected with the feeding carrier plate. The pressing assembly includes a first transmission shaft and a second transmission shaft, the first transmission shaft is sleeved with a lower peeling roller, pressing tooth on the lower peeling roller and pressing tooth on the second transmission shaft are arranged in a staggered mode, and tearing operation of external packaging layers of cables is achieved by up-and-down pressing.

### TECHNICAL FIELD

The present disclosure relates to the field of cable peeling equipment, in particular to equipment for stripping package.

### BACKGROUND ART

Packaged pipe and cable are commonly used in the field of oil exploitation and mainly comprises an external packaging layer and an internal protection pipe. The packaging layer is used for protecting a connecting line between an underground mine and the ground. The external packaging layer at the end needs to be removed when the packaged pipe and cable is used. In the prior art, workers commonly cut off the external packaging layer with wallpaper knives, which is poor in peeling effect, laborious and time-consuming, and is prone to damage the internal protection pipe, and meanwhile the cutting effect is not ideal when materials are high in hardness. Based on this, equipment for stripping package is designed to improve the peeling efficiency and reduce labor intensity of workers.

### SUMMARY

It is an object of the present disclosure to provide equipment for stripping package which achieves an easy and rapid automatic stripping operation using pressing force.

In order to solve the technical problem described above, the present disclosure adopts the following technical solution:

Equipment for stripping package in the present disclosure comprises a supporting frame, a driving air motor, a pressing assembly and a feeding carrier plate, wherein the pressing assembly is mounted in an interior of the supporting frame, an output end of the driving air motor is in transmission connection with the pressing assembly and drives the pressing assembly to achieve cable pressing operation, and a feeding end of the supporting frame is connected with the feeding carrier plate.

Furthermore, the supporting frame comprises two supporting legs and one upper supporting plate, wherein the upper supporting plate is in lap joint with top surfaces of the supporting legs and is connected to the supporting legs by screwing first connecting bolts to form a U-shaped frame body, a lower connecting column is connected between bottoms of the two supporting legs.

Furthermore, the pressing assembly comprises a first transmission shaft and a second transmission shaft which are arranged in parallel, wherein the first transmission shaft and the second transmission shaft are rotatably mounted on the supporting legs by first bearings and second bearings respectively; one end of the first transmission shaft is connected with the driving air motor by a planetary gear carrier, the other end of the first transmission shaft is connected with one end of the second transmission shaft by a gear set, the other end of the second transmission shaft is rotatably connected to inner sides of the supporting legs, the first transmission shaft is sleeved with a lower peeling roller, and pressing tooth on the lower peeling roller and pressing tooth on the second transmission shaft are arranged in a staggered mode; and a height of the feeding carrier plate corresponds to a lap-joint position of the pressing tooth on the lower peeling roller and the pressing tooth on the second transmission shaft.

Furthermore, the gear set comprises a driving gear and a driven gear, wherein the driving gear is connected to the first transmission shaft by a first key, the driven gear is connected to the second transmission shaft by a second key, and the driving gear and the driven gear are meshed to one another and are located on an outer side of one of the supporting legs.

Furthermore, a gear protection cover is arranged on an outer side of the gear set and is connected to an outer side surface of the one of the supporting legs by bolts or rivets.

Furthermore, the second bearings are adjustably connected to the supporting legs by a sliding assembly.

Furthermore, the sliding assembly comprises up-and-down movable sliders and stop screws, the up-and-down movable sliders are slidably mounted in slideways on inner sides of the supporting legs, the second transmission shaft is connected to the up-and-down movable sliders by the second bearings, the stop screws are connected into threaded holes in the upper supporting plate, and bottom end surfaces of the stop screws abut against top surfaces of the up-and-down movable sliders.

Furthermore, a handle is arranged above the upper supporting plate and is connected to a top surface of the upper supporting plate by second connecting bolts.

Furthermore, the feeding carrier plate comprises one bottom plate and two side baffles, wherein a U-shaped groove is formed on top of the bottom plate after the bottom plate connects to the side baffles, and a width of the U-shaped groove is matched with a specification of a to-be-processed cable; a sliding carrier plate is arranged on outer side surfaces of the side baffles, the sliding carrier plate is matched with sliding slots in opposite surfaces of the two supporting legs, positioning screws are arranged on an outer side surface of one of the supporting legs.

Furthermore, a mediate partition plate is arranged in the U-shaped groove.

Compared with the prior art, the present disclosure has the following beneficial effects:
1) external packaging layers of the cables are stripped by pressing of the equipment, several cable cores can be effectively separated, and the separated cable cores are wrapped with internal protective layers and can be directly used for the second time.
2) portable movement of the equipment is achieved by arrangement of the handle.
3) the pressing tooth on the lower peeling roller and the pressing tooth on the second transmission shaft which are arranged in a staggered mode cooperate with each other to generate shearing force to separate external packaging layers, and the external packaging layers are torn to expose internal pipes with feeding of cables during working; the pressing tooth are of a rectangular structure and are not provided with sharp cutting parts, so that the cutting mode implemented by means of pressing does not damage the internal protective layers; in the prior art, when cutting knives are adopted for operation, the internal protective layers and internal conductors are easy to be damaged.
4) the equipment runs by adopting the driving air motor, and the driving air motor communicates with an gas source during working, so that compared with the prior electric driving complex structure, the equipment is smaller in structure and more convenient to use.
5) the equipment is mainly applied to the petroleum industry, and the internal pipes are exposed and the packages are stripped before being used, so that the assembly operation is facilitated during working.

In conclusion, the equipment for stripping package is compact in layout, small in size, convenient and fast to carry, driven by the air motor, time-saving, labor-saving and high in working efficiency, so that labor intensity of workers is reduced.

### BRIEF DESCRIPTION OF THE DRAWINGS

The present disclosure is further illustrated below with reference to the accompanying figures.

FIG. 1 is a schematic view of the equipment for stripping package of the present disclosure;

FIG. 2 is a side view of the equipment for stripping package of the present disclosure;

FIG. 3 is a sectional view taken along line A-A of the present disclosure;

FIG. 4 is a schematic view of a feeding carrier plate of the second embodiment of the present disclosure;

FIG. 5 is a schematic view of a feeding carrier plate of the third embodiment of the present disclosure; and

FIG. 6 is a schematic view of a feeding carrier plate of the fourth embodiment of the present disclosure.

Reference numerals in the accompanying figures: 1, supporting frame; 2, handle; 201, second connecting bolt; 3, driving air motor; 4, pressing assembly; 5, feeding carrier plate; 6, gear protection cover; 7, planetary gear carrier; 8, to-be-processed cable; 9, positioning screw; 101, supporting leg; 102, upper supporting plate; 103, lower connecting column; 104, first connecting bolt;

401, first transmission shaft; 402, driving gear; 403, driven gear; 404, second transmission shaft; 405, first bearing; 406, lower peeling roller; 407, second bearing; 408, up-and-down movable slider; 409, stop screw;

501, side baffle; 502, sliding carrier plate; and 503, mediate partition plate.

### DETAILED DESCRIPTION OF THE EMBODIMENTS

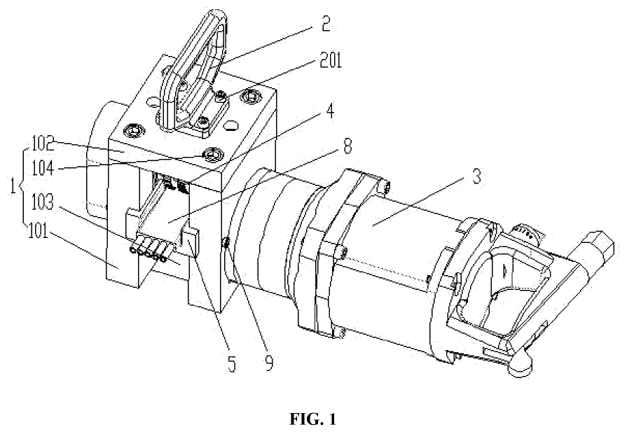

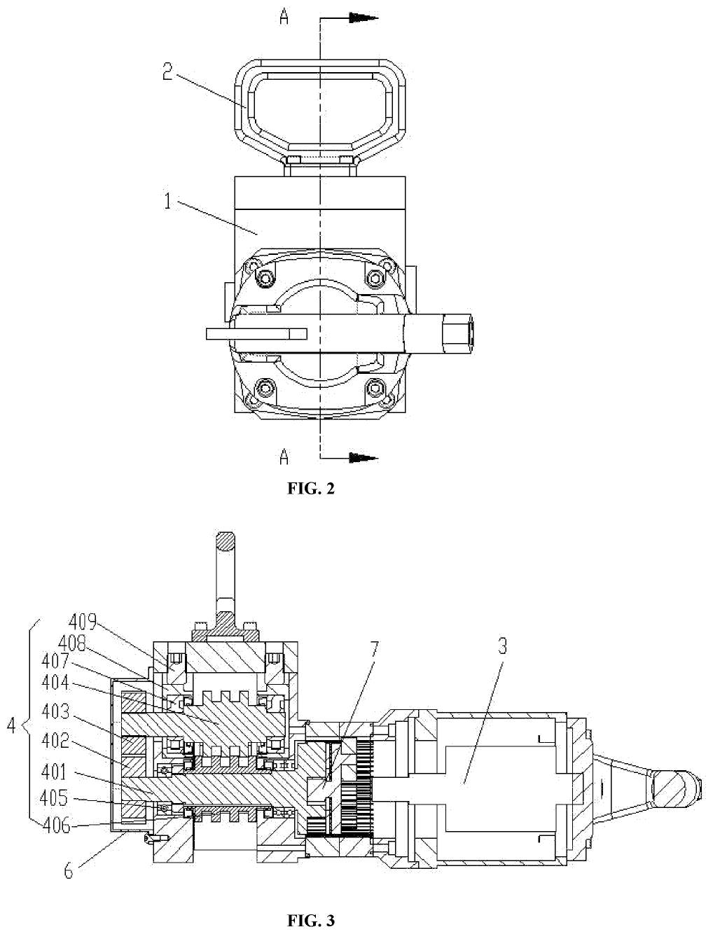

As shown in FIG. 1 to FIG. 3, the equipment for stripping package comprises a supporting frame 1, a driving air motor 3, an pressing assembly 4 and a feeding carrier plate 5, wherein the pressing assembly 4 is mounted in an interior of the supporting frame 1, and an output end of the driving air motor 3 is in transmission connection with the pressing assembly 4 and drives the pressing assembly 4 to achieve cable pressing operation; and a feeding end of the supporting frame 1 is connected with the feeding carrier plate 5, a U-shaped groove is designed in the feeding carrier plate 5, and an inner width of the U-shaped groove is matched with a specification of a to-be-processed cable 8.

Specifically, the supporting frame 1 comprises two supporting legs 101 and one upper supporting plate 102, wherein the upper supporting plate 102 is in lap joint with the top surfaces of the supporting legs 101 and is connected to the supporting legs by screwing first connecting bolts 104 to form a U-shaped frame body, a lower connecting column 103 is connected between the bottoms of the two supporting legs 101 placed in parallel, and the distances between the bottoms of the two supporting legs and the lower connecting column determines the positioning.

As shown in FIG. 3, the pressing assembly 4 comprises a first transmission shaft 401 and a second transmission shaft 404 which are arranged in parallel, wherein the first transmission shaft and the second transmission shaft are rotatably mounted on the supporting legs 101 by first bearings 405 and second bearings 407 respectively; one end of the first transmission shaft is connected with the driving air motor 3 by a planetary gear carrier 7, the other end of the first transmission shaft is connected with one end of the second transmission shaft by a gear set, the other end of the second transmission shaft is rotatably connected to the inner sides of the supporting legs 101, the first transmission shaft 401 is sleeved with a lower peeling roller 406, and pressing tooth on the lower peeling roller and pressing tooth on the second transmission shaft are arranged in a staggered mode; and the height of the feeding carrier plate 5 corresponds to a lap-joint position of the pressing tooth on the lower peeling roller and the pressing tooth on the second transmission shaft. Specifically, the pressing tooth are of a rectangular structure and are not provided with sharp cutting parts, the pressing tooth on the lower peeling roller and the pressing tooth on the second transmission shaft cooperate with each other to generate a shearing force to separate external packaging layers, and internal pipes are exposed with feeding of cables, so that the cutting mode implemented by means of pressing does not damage internal protective layers.

Specifically, the gear set comprises a driving gear 402 and a driven gear 403, wherein the driving gear 402 is connected to the first transmission shaft 401 by a first key, the driven gear 403 is connected to the second transmission shaft 404 by a second key, and the driving gear and the driven gear are meshed to one another and are located on the outer side of one of the supporting legs. A gear protection cover 6 is arranged on the outer side of the gear set and is connected to an outer side surface of the one of the supporting legs by bolts or rivets. Safety of use is improved by the gear protection cover, foreign matters are prevented from entering the gear set, and problems of winding and twisting are also avoided.

The second bearings 407 are adjustably connected to the supporting legs 101 by a sliding assembly. Specifically, the sliding assembly comprises up-and-down movable sliders 408 and stop screws 409, the up-and-down movable sliders are slidably mounted in slideways on inner sides of the supporting legs, the second transmission shaft 404 is connected to the up-and-down movable sliders 408 by the second bearings 407, the stop screws 409 are located right above the up-and-down movable sliders 408 and connected into threaded holes in the upper supporting plate 102, the bottom end surfaces of the stop screws 409 abut against the top surfaces of the up-and-down movable sliders 408, a height of the second transmission shaft is convenient to be adjusted by rotation and thereby up-and-down movement of the stop screws 409, so that the quality during the peeling operation of the cable is guaranteed.

Moreover, a handle 2 is arranged above the upper supporting plate 102 and is connected to the top surface of the upper supporting plate by second connecting bolts 201, so that portable movement of the equipment is achieved.

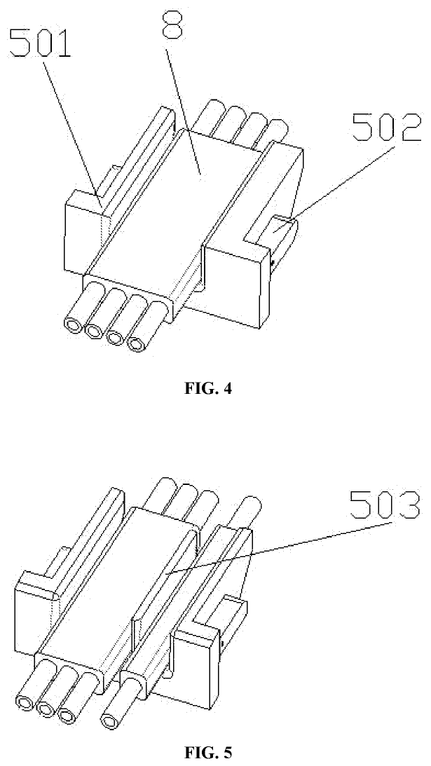

As shown in FIG. 4 to FIG. 6, the feeding carrier plate 5 comprises one bottom plate and two side baffles 501, wherein a U-shaped groove is formed on top of the bottom plate after the bottom plate connects to the side baffles, and the width of the U-shaped groove is matched with the specification of the to-be-processed cable 8, a sliding carrier plate 502 is arranged on the outer side surfaces of the side baffles 501, the sliding carrier plate is matched with sliding slots in opposite surfaces of the two supporting legs, positioning screws 9 are arranged on an outer side surface of one of the supporting legs, and the positioning screws 9 penetrate through the one of the supporting legs 101 and then are screwed and connected into threaded holes on the side face of the sliding carrier plate 502.

Specifically, the width of the U-shaped groove in the feeding carrier plate 5 can be adjusted to meet the peeling requirement of cables of different specifications by adjusting the widths of the side baffles 501. As shown in FIG. 1, when the thicknesses of the two side baffles 501 are consistent, the U-shaped groove is the widest, and the feeding carrier plate is suitable for peeling operation of five core cables; and as shown in FIG. 4, the thickness of the right one of the baffles is increased, the U-shaped groove becomes narrower, and the feeding carrier plate is suitable for peeling operation of four core cables.

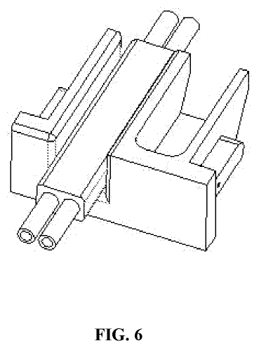

As shown in FIG. 5, a mediate partition plate 503 is arranged in the U-shaped groove, two positioning grooves for to-be-processed cables are formed in two sides of the mediate partition plate, the left one of the two positioning grooves for to-be-processed cables is suitable for peeling operation of three core cables, and right one of the two positioning grooves for to-be-processed cables is suitable for peeling operation of one core cable. As shown in FIG. 6, the side baffles continue to be thickened or are connected with a mediate partition plate 503 to close the right one of the two positioning grooves for to-be-processed cables, then only the left one of the two positioning grooves for to-be-processed cables, which is narrower, is reserved, and the feeding carrier plate is suitable for peeling operation of two core cables.

Therefore, the stripping operation of different cables can be achieved by the cooperation of the pressing assembly and a plurality of feeding carrier plates, and the feeding carrier plates are convenient and fast to be replaced.

The working process is as follows:

First, the second transmission shaft 404 is adjusted to a proper height, the stop screws 409 are screwed for positioning the second transmission shaft 404, and then the driving air motor 3 is communicated with an air source, the control button is turned on, then the cables are fed inwards from the groove of the feeding carrier plate 5, and the driving air motor drives the first transmission shaft 401 and the lower peeling roller 406 sleeved thereon to rotate by the planetary gear carrier 7; meanwhile, the driving gear 402 and the driven gear 403 which are meshed to one another at the ends thereof drive the second transmission shaft 404 to rotate, the pressing tooth which are vertically arranged in a staggered mode are matched to tear the external packaging layers of the cables, after the external packaging layers of the cables are torn to a specified length, the cables are drawn backwards, and the external packaging layers of torn sections are cut off to expose the internal pipes, and then corresponding connection operation is performed.

The equipment can be carried and used at any time, is operated pneumatically, labour-saving and time-saving, and has good tearing quality without damaging the internal protective layers of the cables.

The embodiments described above only describe preferred modes of the present disclosure and do not limit the scope of the present disclosure. Various modifications and improvements made to the technical solution of the present disclosure by those skilled in the art will fall within the scope of protection as determined by the claims of the present disclosure without departing from the spirit of the design of the present disclosure.

1. An apparatus for stripping package comprises:
a supporting frame;
a driving air motor;
a pressing assembly; and
a feeding carrier plate;
wherein the pressing assembly is mounted in an interior of the supporting frame, an output end of the driving air motor is in transmission connection with the pressing assembly and is adapted to the pressing assembly to achieve cable pressing operation, and a feeding end of the supporting frame is connected with the feeding carrier plate.

2. The apparatus for stripping package according to claim 1, wherein the supporting frame includes two supporting legs and one upper supporting plate, the upper supporting plate is in lap joint with top surfaces of the supporting legs and is connected to the supporting legs by first connecting bolts to form a U-shaped frame body, and a lower connecting column is connected between bottoms of the two supporting legs.

3. The apparatus for stripping package according to claim 2, wherein the pressing assembly includes a first transmission shaft and a second transmission shaft arranged in parallel, wherein the first transmission shaft and the second transmission shaft are rotatably mounted on the supporting legs by first bearings and second bearings respectively; one end of the first transmission shaft is connected with the driving air motor by a planetary gear carrier, another end of the first transmission shaft is connected with one end of the second transmission shaft by a gear set, another end of the second transmission shaft is rotatably connected to inner sides of the supporting legs, the first transmission shaft is sleeved with a lower peeling roller, and a pressing tooth on the lower peeling roller and a pressing tooth on the second transmission shaft are arranged in a staggered mode; and a height of the feeding carrier plate corresponds to a lap-joint position of the pressing tooth on the lower peeling roller and the pressing tooth on the second transmission shaft.

4. The apparatus for stripping package according to claim 3, wherein the gear set includes a driving gear and a driven gear, the driving gear is connected to the first transmission shaft by a first key, the driven gear is connected to the second transmission shaft by a second key, the driving gear and the driven gear are meshed to one another and are located on an outer side of one of the supporting legs.

5. The apparatus for stripping package according to claim 4, wherein a gear protection cover is arranged on an outer side of the gear set and is connected to an outer side surface of the one of the supporting legs by bolts or rivets.

6. The apparatus for stripping package according to claim 3, wherein the second bearings are adjustably connected to the supporting legs by a sliding assembly.

7. The apparatus for stripping package according to claim 6, wherein the sliding assembly includes up-and-down movable sliders and stop screws, the up-and-down movable sliders are slidably mounted in slideways on inner sides of the supporting legs, the second transmission shaft is connected to the up-and-down movable sliders by the second bearings, the stop screws are connected into threaded holes in the upper supporting plate, and bottom end surfaces of the stop screws abut against top surfaces of the up-and-down movable sliders.

8. The apparatus for stripping package according to claim 2, wherein a handle is arranged above the upper supporting plate and is connected to a top surface of the upper supporting plate by second connecting bolts.

9. The apparatus for stripping package according to claim 2, wherein the feeding carrier plate includes one bottom plate and two side baffles, a U-shaped groove formed on top of the bottom plate by the bottom plate connecting to the side baffles, and a width of the U-shaped groove is matched with a specification of a to-be-processed cable; and a sliding carrier plate is arranged on outer side surfaces of the side baffles, the sliding carrier plate is matched with sliding slots in opposite surfaces of the two supporting legs, and positioning screws are arranged on an outer side surface of one of the supporting legs.

10. The apparatus for stripping package according to claim 9, wherein a mediate partition plate is arranged in the U-shaped groove.
